(19) United States
(12) Patent Application Publication
(10) Pub. No.: US 2009/0261515 A1
(43) Pub. Date: Oct. 22, 2009

(54) Process for Making Disposable Milk Bottle Inner Tube

(76) Inventor: Jianming Li, Guangdong Province (CN)

Correspondence Address: BACON & THOMAS, PLLC, 625 SLATERS LANE, FOURTH FLOOR, ALEXANDRIA, VA, 22314-1176, US

(21) Appl. No.: 12/227,605

(22) PCT Filed: Apr. 23, 2007
(86) PCT No.: PCT/CN2007/001342

§ 371 Date: Nov. 21, 2008

(30) Foreign Application Priority Data
May 26, 2006 (CN) 200610035617.2

(51) Int. Cl. B29C 49/50

(52) U.S. Cl. 264/544

(57) ABSTRACT

A process for making disposable milk bottle inner tube includes the following steps: (a) selecting a metallocene linear low density polyethylene and a low density polyethylene and mixing them in the ratio of 40%-80% to 20%-60%, and then adding 2-6% of anti-blocking agent and 0.02%-0.04% of slip agent; (b) producing sheet by heating, extruding, rolling, pulling, winding and cutting; and (c) blow molding.

### FIELD OF THE PRESENT INVENTION

The present invention relates to a process in “process for making disposable milk bottle inner tube” particularly.

### BACKGROUND OF THE INVENTION

Currently, the demand for the disposable commodity by the people is increased day by day. For the disposable supple baby bottle liner, user complaints are increased because of tedious and troublesome operation in usage, being easily contaminated by the content therein and being easily breakable upon dropping to the ground. For conventional disposable drinking cup, other than the material, diameter and containing volume thereof are not compatible with those of the conventional baby bottles, the tensile strength and impact durability as well as fabrication with materials neither meet the specifications of various baby bottles nor pass the criterion of the standard containing volume.

### SUMMARY OF THE INVENTION

The object of the present invention is to provide a “process for making disposable milk bottle inner tube” with features of simple and reasonable process, nontoxic ingredients of raw material, no harmful affections to the color and taste of the food therein, user-friend easiness in operation, excellent endurance to the impact and compatibility with the conventional baby bottles prevalent currently.

The object aforesaid of the present invention can be accomplished by the following implementation means that a process for making disposable milk bottle inner tube comprises following procedures:

(a). Selection and Blend of the Raw Materials: Select metallocene lineal low density polyethylene (mLLDPE) and low density polyethylene (LDPE) as primary ingredients, and add certain proportional percentage of anti-blocking agent and slippery agent as property modifiers, then blend 40%˜80% of the (mLLDPE) with 60%˜20% of the (LDPE) in weight proportion, as well as add 0.2%˜0.6% weight of the anti-blocking agent and 0.02%˜0.04% weight of slippery agent;

(b). Pre-process into the Plastic Sheets: After all the raw materials aforesaid have been well mingled as desired, pass the blend of the raw materials stepwise through pre-processing procedures of heating, extruding, calendaring, drawing, rolling into spool and cutting into sheets to become a plastic sheet with length of desire, width of 300 mm˜1200 mm and thickness of 0.3 mm˜2.0 mm, wherein the drawing speed of the drawing procedure is kept between 2.0˜4.3 meter per minute.

(c). Blow Molding of the Plastic Sheets: Load orderly the plastic sheets from foregoing pre-processing procedures into the disposable baby bottle liner-making machine to heat it up with temperature profile in 100°˜380° in the oven therewith, wherein the rotational speed of the driving motor for feeding materials therein is regulated within 400˜500 rpm such that the feeding throughput is 40 mm˜500 mm per minute. Then, orderly form the processed plastic sheets from foregoing procedures in the preset mold via compressed air with forming throughput is 1˜30 mold per minute and forming air pressure ranges in 0.2 mPa˜0.6 mPa, preferably 0.5 mPa. After the formation of the baby bottle liner, each of which is cut apart at the blow molding exit by a cutter. Then, each shaped baby bottle liner together with mold is individually pushed up by an uplifting lever to the exiting level, where the shaped baby bottle liner is ejected off the mold by compressed air.

The object accomplished of the present invention can also be further enhanced by the following implementation means: The shape-finished baby bottle liner has tensile strength at break between 4000 Psi˜6000 Psi when the depth thereof reaching 30 mm˜250 mm. The mixing ratio of the (mLLDPE) to the (LDPE) is 40%:60% if the depth of the shape-finished baby bottle liner is between 30 mm˜100 mm, while the mixing ratio of the (mLLDPE) to the (LDPE) is 80%:20% if the depth of the shape-finished baby bottle liner is between 101 mm˜250 mm. The gap between two blades of the cutter in the procedure (c). “Blow Molding of the Plastic Sheets” is around 0.05 mm˜0.01 mm. The final finished baby bottle liner formed is dimensioned with thickness for the rim of the top open end thereof is 0.2 mm˜1.9 mm, thickness for the truncated conical side wall thereof is 0.02 mm˜0.15 mm, thickness for the closed bottom end thereof is 0.1 mm˜1.5 mm. The final finished baby bottle liner formed has a visible measuring scale is graduated on the outer surface of the truncated conical side wall thereof for checking the volume of the content therein. Said metallocene lineal low density polyethylene (mLLDPE) can select product of 1018FA mLLDPE in Exceed™ series from ExxonMobil Chemical Company (www.exxonmobilchemical.com).

Comparing to the current conventional process, the process for making disposable milk bottle inner tube in the present invention has following advantages: (1). Simple and reasonable process; (2). The specification of the baby bottle liner produced by the present invention has diameter for the top opening being less than 48 mm and containing volume reaching 10 ounces to be compatible with the conventional baby bottles currently; (3). Low manufacturing cost; (4). Preclude the boring task in rinsing the baby bottle; (5). Easy stack, less space occupied, suitable for carrying out; (6). No harmful affection to the color and taste of the content therein due to nontoxic materials adopted; (7). User-friend easiness in operation and excellent endurance to the impact, whose feature substantially exceeding that of the current conventional baby bottle liners.

### BRIEF DESCRIPTION OF THE DRAWINGS

No Drawings

### DETAILED DESCRIPTION OF THE PREFERRED EMBODIMENTS

The detailed disclosure of the present invention is described as below in association with preferred exemplary embodiment. The fabricating process comprises following steps of:

(a). Selection and Blend of the Raw Materials:

Select metallocene lineal low density polyethylene (mLLDPE) and low density polyethylene (LDPE) as primary ingredients, and add certain proportional percentage of anti-blocking agent and slippery agent as property modifiers. Wherein, said metallocene lineal low density polyethylene (mLLDPE) can select products of 1012CA, 1012MV, 1018CA, 1018FA, 1018EB, 1018EA, 1018DA, 1023CA, 1327CA, 1327ED, 2018CA, 3518CB, 3518PA, 3527CB or 4518PA from ExxonMobil Chemical Company (www.exxonmobilchemical.com), preferably 1018FA mLLDPE in Exceed™ series; Said low density polyethylene (LDPE) can select any type from “ExxonMobil™ LDPE”; Said anti-blocking agent can preferably select the oleylamide from the Shanghai Huayi Plastics Auxiliary Cooperation Company in China (www.huayichem.com/pro-e.asp); and Said slippery agent can preferably select the product HTSA#3 from USA Fine Organics Chemicals (Pty) Ltd. (www.fineorganics.co.za).

For blending raw materials, mix 40%˜80% of the (mLLDPE) with 60%˜20% of the (LDPE) in weight proportion, then add 0.2%˜0.6% weight of the anti-blocking agent and 0.02%˜0.04% weight of slippery agent such that the shape-finished baby bottle liner can have tensile strength at break between 4000 Psi˜6000 Psi when the depth thereof reaching 30 mm˜250 mm as well as pass the test criterion of falling to the ground, which is namely that directly dropping vertically the baby bottle liner produced by the present invention fully filled with hot water in temperature of 40□ from height of 1˜1.5 meter iteratively for 4 times, the testing result of the subject baby bottle liner should be intact without any breakage.

For more specific blending proportion, the mixing ratio of the (mLLDPE) to the (LDPE) is 40%:60% if the depth of the shape-finished baby bottle liner is between 30 mm˜100 mm, while the mixing ratio of the (mLLDPE) to the (LDPE) is 80%:20% if the depth of the shape-finished baby bottle liner is between 101 mm˜250 mm; Whereas the quantity of the introduced anti-blocking agent is 0.4% and that of the slippery agent is 0.03%.

(b). Pre-process into the Plastic Sheets:

After all the raw materials aforesaid have been well mingled as desired, pass the blend of the raw materials stepwise through pre-processing procedures of heating, extruding, calendaring, drawing, rolling into spool and cutting into sheets to become a plastic sheet with length of desire, width of 300 mm˜1200 mm and thickness of 0.3 mm˜2.0 mm, wherein the temperature in the heating procedure is within 180□˜250□, and each speed of the extruding, calendaring and drawing procedures should be kept between 2.0˜4.3 meter per minute, preferably 3.2 meter per minute so as to have smooth and uniform evenness surface for the plastic sheets; and

(c). Blow Molding of the Plastic Sheets: Load orderly the plastic sheets from foregoing pre-processing procedures into the disposable baby bottle liner-making machine, whose structure and operational principle are the same as those of the disposable plastic cup-making machine, namely cluster of plastic thermoforming machine, to heat it up with temperature profile in 100□˜380□, preferably 240□, as well as to disinfect and sterilize by stage manner in the oven therewith, wherein the rotational speed of the driving motor for feeding materials therein is regulated within 400˜500 rpm, preferably 450 rpm, such that the feeding throughput is 40 mm˜500 mm per minute. Then, orderly form the processed plastic sheets from foregoing procedures in the preset mold via compressed air with forming throughput is 1˜30 mold per minute, preferably 15 mold per minute, and forming air pressure ranges in 0.2 mPa˜0.6 mPa, preferably 0.5 mPa. After the formation of the baby bottle liner, each of which is cut apart at the blow molding exit by a cutter, whose gap between two blades thereof is around 0.05 mm˜0.01 mm. Then, each shaped baby bottle liner together with mold is individually pushed up by an uplifting lever to the exiting level, where the shaped baby bottle liner is ejected off the mold by compressed air. The final finished baby bottle liner formed by the foregoing procedures is dimensioned with thickness for the rim of the top open end thereof is 0.2 mm˜1.9 mm, thickness for the truncated conical side wall thereof is 0.02 mm˜0.15 mm, preferably 0.05 mm, thickness for the closed bottom end thereof is 0.1 mm˜1.5 mm, preferably 0.3 mm, and has a visible measuring scale graduated on the outer surface of the truncated conical side wall thereof for checking the volume of the content therein.

What is claimed is:

1. A “process for making disposable milk bottle inner tube” comprises following steps of:
(a). Selection and Blend of the Raw Materials: Select metallocene lineal low density polyethylene (mLLDPE) and low density polyethylene (LDPE) as primary ingredients, and add certain proportional percentage of anti-blocking agent and slippery agent as property modifiers, then blend 40%˜80% of the (mLLDPE) with 60%˜20% of the (LDPE) in weight proportion, as well as add 0.2%˜0.6% weight of the anti-blocking agent and 0.02%˜0.04% weight of slippery agent;
(b). Pre-process into the Plastic Sheets: After all the raw materials aforesaid have been well mingled as desired, pass the blend of the raw materials stepwise through pre-processing procedures of heating, extruding, calendaring, drawing, rolling into spool and cutting into sheets to become a plastic sheet, wherein the temperature in the heating procedure is within 180□˜250□, and the drawing speed in the drawing step is kept between 2.0˜4.3 meter per minute; and
(c). Blow Molding of the Plastic Sheets: Load orderly the plastic sheets from foregoing pre-processing procedures into the disposable baby bottle liner-making machine to heat it up with temperature profile in 100□˜380□ by stage manner in the oven therewith; And, orderly form the processed plastic sheets from foregoing procedures in the preset mold via compressed air with forming air pressure ranges in 0.2 mPa˜0.6 mPa.

2. A process for making disposable milk bottle inner tube as recited in claim 1, wherein said plastic sheet from the procedure “(b) Pre-process into the Plastic Sheets” dimensions with length of desire, width of 300 mm˜1200 mm and thickness of 0.3 mm˜2.0 mm.

3. A process for making disposable milk bottle inner tube as recited in claim 1, wherein the drawing speed of the drawing step in the procedure “(b) Pre-process into the Plastic Sheets” is 3.2 meter per minute.

4. A process for making disposable milk bottle inner tube as recited in claim 1, wherein a material feeding step is intervened between the preceding heading step and the subsequent forming step by compressed air in the procedure “(c) Blow Molding of the Plastic Sheets” having the rotational speed of the driving motor for feeding materials therein is regulated within 400˜500 rpm such that the feeding throughput is 40 mm˜500 mm per minute.

5. A process for making disposable milk bottle inner tube as recited in claim 4, wherein the forming throughput in the forming step by compressed air is 1˜30 mold per minute.

6. A process for making disposable milk bottle inner tube as recited in claim 1, wherein after the formation of the baby bottle liner, each of which is cut apart at the blow molding exit by a cutter. Then, each shaped baby bottle liner together with mold is individually pushed up by an uplifting lever to the exiting level, where the shaped baby bottle liner is ejected off the mold by compressed air.

7. A process for making disposable milk bottle inner tube as recited in claim 1, wherein the heating temperature of the oven associated with the liner-making machine in the procedure “(c). Blow Molding of the Plastic Sheets” is 240□ and the forming air pressure therein is 0.5 mPa.

8. A process for making disposable milk bottle inner tube as recited in claim 5, wherein the rotational speed of the driving motor for feeding materials therein is regulated to 450 rpm, and the forming throughput is 15 mold per minute,

9. A process for making disposable milk bottle inner tube as recited in claim 1, wherein the shape-finished baby bottle liner has tensile strength at break between 4000 Psi˜6000 Psi when the depth thereof reaching 30 mm˜250 mm.

10. A process for making disposable milk bottle inner tube as recited in claim 1, wherein the mixing ratio of the (mLLDPE) to the (LDPE) is 40%:60% if the depth of the shape-finished baby bottle liner is between 30 mm˜100 mm, while the mixing ratio of the (mLLDPE) to the (LDPE) is 80%:20% if the depth of the shape-finished baby bottle liner is between 101 mm˜250 mm.

11. A process for making disposable milk bottle inner tube as recited in claim 6, wherein the gap between two blades of the cutter is around 0.05 mm˜0.01 mm.

12. A process for making disposable milk bottle inner tube as recited in claim 1, wherein the final finished baby bottle liner formed is dimensioned with thickness for the rim of the top open end thereof is 0.2 mm˜1.9 mm, thickness for the truncated conical side wall thereof is 0.02 mm˜0.15 mm, thickness for the closed bottom end thereof is 0.1 mm˜1.5 mm.

13. A process for making disposable milk bottle inner tube as recited in claim 1, wherein the final finished baby bottle liner formed has a visible measuring scale is graduated on the outer surface of the truncated conical side wall thereof for checking the volume of the content therein.
